(19) United States
(12) Patent Application Publication
(10) Pub. No.: US 2004/0178624 A1
(43) Pub. Date: Sep. 16, 2004

(54) Novelty business card

(76) Inventor: Kevin Kawasaki, Belmont, CA (US)

Correspondence Address: Arthur S. Hsieh, Morrison & Foerster LLP, 755 Page Mill Road, Palo Alto, CA, 94304-1018, US

(21) Appl. No.: 10/388,551

(22) Filed: Mar. 13, 2003

(51) Int. Cl. G09C 3/00

(52) U.S. Cl. 283/74

(57) ABSTRACT

A novelty business card with one or more edges configured for facilitating the removal of debris from surfaces. The card is designed to be compact and may be easily handled with human hand. Lettering, logos, and other messages may be printed on the front and/or back surfaces of the card for information distribution purposes. In one variation, the novelty business card has a squeegee attached to one of its four edges. In another variation, a scraping surface is provided on one of the edges on the business card in addition to the edge with a squeegee. In an alternative design, a brush may also be provided on the novelty business card. The novelty business card may serve the dual purpose as an information distribution medium and as a compact debris removal device.

### FIELD OF THE INVENTION

The present invention relates to a compact device for wiping, spreading or pushing materials from a relatively smooth surface. The inventive device is designed to facilitate removal of various debris, e.g. dirt, snow and water, from a smooth surface such as a car windshield and at the same time serve as an information distribution medium for marketing purposes. Specifically, the device may be a business card having typical dimensions of such a card.

### BACKGROUND OF THIS INVENTION

It is common for automobile operators to discover bird droppings, dirt, dried insets and other debris on the windshield or other surfaces of their cars. In many instances, such debris had been attached to the car surface for an extended period of times and had solidified or bonded to the surfaces of the car. Car washing and regular wiping often fails to remove these hardened debris.

Various devices have been devised for cleaning the windshield of a car. However, much of the prior work focused on removing snow and ice from the windshield. In addition, these devices tend to be large and bulky. Examples of such devices are disclosed in U.S. Pat. No. 2,277,528, issued Mar. 24, 1942 to Osborn; U.S. Pat. No. 3,229,316, issued Jan. 18, 1966 to Matheson; U.S. Pat. No. 5,709,005, issued Jan. 20, 1998 to Brach, Jr. et al.; U.S. Pat. No. 5,857,237, issued Jan. 12, 1999 to Dranginis; U.S. Pat. No. 5,009,540, issued Mar. 31, 1992 to Paschetto; U.S. Pat. No. Des. 320,483, issued Oct. 1, 1991 to Desautel; U.S. Pat. No. Des. 349,592, issued Aug. 9, 1994 to Stoll; and U.S. Pat. No. Des. 426,757, issued Jun. 20, 2000 to McGrellis; each of which is incorporated here in by reference in its entirety.

A compact and easily carried device for removing debris from windshields and outer surfaces of the car is much desired. Preferably, the device may be utilized for removal of hardened debris as well as soft or liquid materials from the metallic surfaces of the car without causing significant damage. Furthermore, such device may also carry logos and/or other messages so that it may serve as a marketing medium. For example, devices such as these may be handed out at car washes, gas stations, auto dealers, and trade shows for promotional purposes. Thus, a dual-purpose marketing and debris removal device that is compact and easy to handle may be desirable.

### SUMMARY OF THE INVENTION

The present invention includes a card-shaped device for removal of debris (e.g. dirt, bird droppings, snow, ice, water, etc.) from the outer surface of a car. The present invention may provide a pliable edge on the card shaped device for removing debris without inflicting damages to the underlying surface. The card may have logos, markings or other messages for information distribution purposes.

The device may be designed to serve as and be shaped like a business card. Alternatively, the device may be slightly larger or smaller, but maintains the general width and length proportion so that it may be easily identified as a business card. The device may be thicker than a traditional business card such that sufficient strength and/or durability may be achieved. Alternatively, it may be the size of a credit card or it may be squared shaped.

Generally the device is relatively thin and compact such that it may be easily handled and transferred with human hands. The compact design may also allow easy storage. For example, it may be configured such that it can easily fit into a purse, a wallet, a glove compartment, or a coin/ash tray in a car.

The novelty business card may have one or more flexible and/or compliant edges for facilitating removal of liquid or residue from a surface. In one aspect of the design, “squeegee” materials are provided on one or more of the four edges of the card device. For example a blade of rubber or polymeric material attached to one of the four edges on the card may be used for spreading, pushing or wiping materials across or off a relatively smooth surface. The device may further comprise a scraping edge in addition to the squeegee edge. The scraping edge may allow the user to remove materials that have solidified or hardened. In another variation, a brush may be adapted to one of the edges on the device. For example, the card device may have a squeegee edge at one end and a brush edge on the another. Alternatively, the card device may also have a squeegee edge, a scraping edge and a brush edge, or any combination thereof.

The squeegee feature may be particularly useful for removing debris from the metallic surfaces of the car since scraping of metallic surface with a hard edge may leave scratches and other marks. In addition, cloth, sponge or other soft materials may not allow the user to exert enough pressure to remove the debris that had attached or stuck to the surface of the car. The scraping edge may be useful for removing bird droppings, and other debris that have attached to the windshield and other window surfaces. The brushing edge may allow the user to dust small areas or openings both inside and outside the card. For example, vents and real view mirrors may have dust particles buildup that need to be removed.

Advertising indicia (e.g., logos, markings, messages, name, address, telephone number, etc.) and/or other information may be printed or formed on the surface of the card devices so they may be distributed to the public for promotional or other marketing purposes. In particular, the device may include printed material on one side, of the same configuration and spacing found on a normal business card, e.g., name and title in the center and company, address, phone number, email address, etc. in a corner. The reverse side may have the same information in another language.

In one variation, low cost materials and processes may be used for mass production of the device. The resulting low cost product may be useful for mass distribution or for disposable applications. Car washes, gas stations, and car dealers may distribute these devices to customers or potential customers for marketing purposes. The customer may use these devices to remove bird droppings, other animal defecate, bugs and other debris from the windshield, head lights or other surfaces on a car.

These and other embodiments, features and advantages of the present invention will become more apparent to those skilled in the art when taken with reference to the following more detailed description of the invention in conjunction with the accompanying drawings.

### BRIEF DESCRIPTION OF THE DRAWING

In the accompanying drawings, reference characters refer to the same parts throughout the different views. The drawings are intended for illustrating some of the principles of the novelty business card and are not intended to limit the invention in any way. The drawings are not necessarily to scale, emphasis instead being placed upon illustrating the depicted principles in a clear manner.

FIG. 1 illustrates one variation of a novelty business card having a squeegee attached on one edge of the card and an opposite edged is configured for scrapping purposes.

FIG. 2 is a cross-sectional view of another variation of a novelty business card where the scrapping edge is a separate part that is attached to the body of the card.

FIG. 3A is yet another variation of a novelty business card. In this variation a squeegee material completely surrounds the peripheries of the card.

FIG. 3B is the side view of the novelty business card shown in FIG. 3A.

FIG. 4A illustrates one variation of a squeegee connected to the body of a card device. In this variation, the squeegee has a triangular shaped surfaces and a rod shaped extension for interlocking with the body of the card.

FIG. 4B illustrates another variation of a squeegee connected to the body of a card device with adhesives. In this variation, the squeegee gradually thinout as it extends away from the card.

FIG. 4C illustrates yet another variation of a squeegee connected to the body of a card device. In this variation, the squeegee has a rod-like extension with linear groves on the surface of the rod. In addition, a rectangular shaped extension is provided for interlocking with the card.

FIG. 4D illustrates yet another variation of the squeegee connected to the body of a card device. In this variation the surface of the squeegee are jagged and uneven. In addition a rod shaped extension is provided for interlocking with the body of the card.

FIG. 4E illustrates yet another variation of the squeegee attached to the body of a card device. In this variation the squeegee comprises of two blade extensions.

FIG. 4F illustrates yet another variation of the squeegee attached to the body of the card device. In this variation, the squeegee has a partially circular cross-section with groves on the surface of the squeegee.

FIG. 5A shows one variation of a scraping edge with slanted surface and indentations.

FIG. 5B shows another variation of a scraping edge with multiple tooth-like extensions.

FIG. 6 shows another variation of a card device where a squeegee is attached to the lower edge of the card and the upper edge of the card is double beveled.

FIG. 7 shows another variation of a card device having two scraping edge and one squeegee edge. The left edge is configured as a scraping edge with saw like extensions. The upper edge is also configured as a scraping edge with a slanted surface. The bottom edge has a squeegee attached along the width of the edge surfaces.

FIG. 8 shows one variation of a squared shaped card having a squeegee attached to the top edge and the bottom edge configured as a scraping edge.

FIG. 9 is a perspective view of another variation of a novelty business card having a top edge with a brush extension and a bottom edge with a squeegee extension.

FIG. 10 is a perspective view of yet another variation of a novelty business card having a right edge with a brush extension, a bottom edge with a squeegee extension and a top edge with a beveled scraping surface. A bottle opener is further incorporated into the novelty business card. An optional key ring hole is also shown in the lower left corner of the device.

### DESCRIPTION OF THE INVENTION

Before describing the present invention, it is to be understood that unless otherwise indicated cleaning of car surfaces is used herein as an example application to illustrate the functionality of the different aspects of the invention disclosed herein. It will be understood that embodiments of the present invention may be applied in a variety of cleaning and debris clearing applications and are not limited to cleaning the surfaces on a car. Furthermore, the term “squeegee” means one or more pieces of pliable and/or flexible material used for spreading, pushing, or wiping liquid material on, across, or off a surface.

It will also be understood that embodiments of the present invention may be applied in combination with various cleaning devices and processes, and it is not limited to the specific examples describe herein.

It must also be noted that, as used in this specification and the appended claims, the singular forms “a,” “an” and “the” include plural referents unless the context clearly dictates otherwise. Thus, for example, the term “a scraping edge” is intended to mean a single scraping edge or a plurality of scraping edges, “a squeegee” is intended to mean one or more squeegee, or a combination there of.

One variation provides a card shaped device with at least one edge of the card having a squeegee material. Preferably, the device is compact such that it may be easily handled and distributed by human hands. It is even more preferable that the device may fit in the palm of an average adult in the United States. In one variation, the device 2 is about the size of a business card. A squeegee 4 may be attached to one edge of the card as seen in FIG. 1. Another edge 6 of the card may be configured with a shape adapted for scraping. Lettering, logos, messages and/or markings may be provided on the front surfaces 8 of the card. Optionally, the back surface of the card may also have messages and/or markings. The card may be thicker than the usual business card to provide appropriate stiffness.

In another variation, the device is the size of a business card commonly used in the United States, having a width (“W” in FIG. 1) of about 3.5 inches and a length (“L” in FIG. 1) of about 2 inches. Alternatively, the device may be the size of a business card commonly used in Asia, having a width of about 9 centimeters and a length of about 5.4 centimeters. In another variation, the device is about the size of a credit card, having a width of about 3 and 3/8 inches and a length of about 2 and 1/8 inches. In yet another variation, the device is about the size of a standard playing card, having a width of about 2 and 1/4 inches and a length of about 3 and 1/2 inches. The device may also be squared shape. In one variation, the device is about 3 inches by about 3 inches. In another variation, the device is about 2 and 1/2 inches by about 2 and 1/2 inches. In yet another variation, the device is about 2 inches by about 2 inches. The devices may be various rectangular shapes, but generally it is preferable that the width and length are each equal or less than 4 inches. It is more preferable, the width and length are each equal or less than 3 and 1/2 inches.

The corners of the card shaped device may be squared (an example is shown in FIG. 1), or may be rounded (an example is shown in FIG. 3A). All four corners of the card may be squared or they may all be rounded. Alternatively, two corners are rounded and two corners are squared. It may also be possible that only one of the corner is rounded or squared. In an alternative design, one or more of the corners may be indented or absent. Even if one or more of the corners are missing, it is preferable that the device maintains a general shape of a card.

The height of the device may be greater than the thickness of a business car or credit card. The greater thickness provides increased strength and durability in the device so that appropriate pressure may be applied with the device for scraping and/or wiping. Preferably the height of the device is less than 1 centimeter. More preferably, the height of the device is less than 0.8 centimeter. Even more preferably, the height of the device is less than 0.5 centimeter. Further more preferably the height of the device is less than 0.3 centimeter. And most preferably, the device less than 0.2 centimeter.

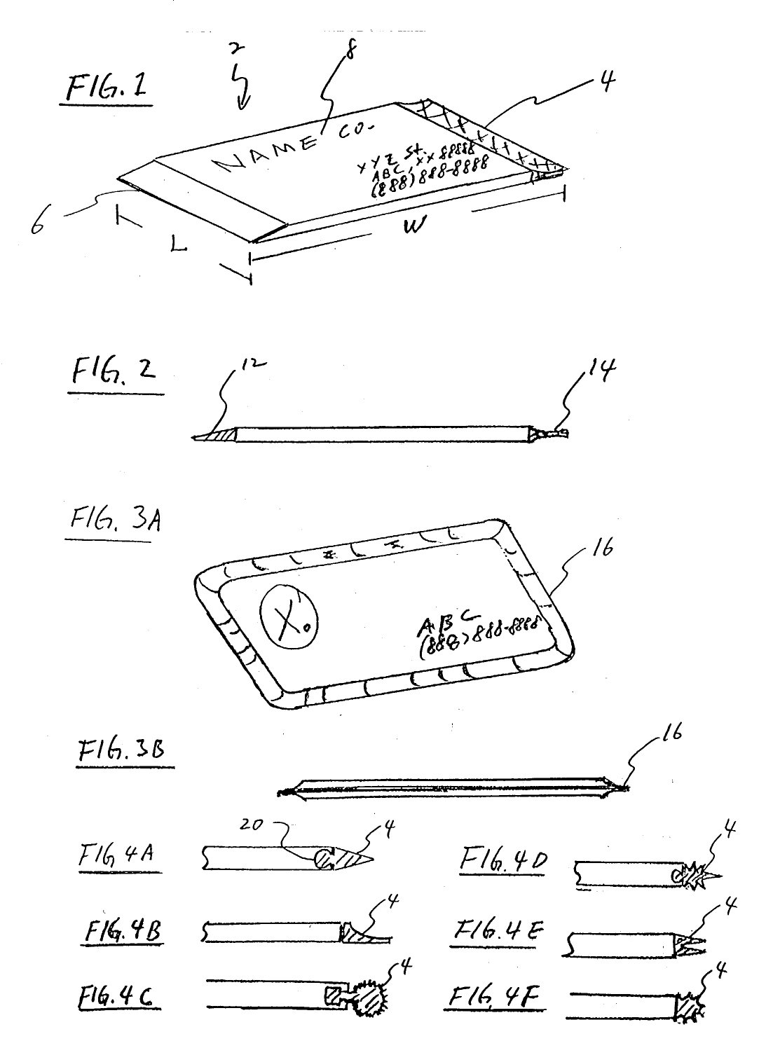

As discuss earlier, one of the edges of the card shaped device may have a squeegee surface. However, more than one of the edges may also have squeegee surfaces. In one variation, two of the edges have squeegee surfaces. The two edges with squeegee surfaces may be opposite each other or may be adjacent to each other. For example, FIG. 2 illustrates a card with two separate squeegee edges 12, 14. In this example, the two squeegees 12, 14, have different shapes. In another variation, three of the edges have squeegee surfaces. In yet another variation, all four edges have squeegee surfaces 16, as seen in FIG. 3A. FIG. 3B illustrates a side few of this particular design.

The squeegee materials attached to the edge of the business card for forming the squeegee surfaces may comprised of various pliable and/or flexible materials that are well known to one skill in the art for constructing squeegees. For example, the squeegee may comprise of natural rubber, synthetic rubber, foam rubber, silicone, neoprene, polyurethane, thermoplastic, flexible plastic materials, thermoplastic elastomer, a combination of various thermoplastic, or a combination of one or more of the polymers described above. The squeegee may also be made by combining plyurethane/urethane elastomers with a dense polyester fill.

The body of the card device may comprise of metal, metal alloys, plastic, or polymers such as polystyrene, acrylic, PVC, ABS, polycarbonate or other hard polymeric materials that are well known to one skilled in the art. When large quantities are desired, the device may be made by extrusion or by injection molding. Alternatively, the device may be fabricated through lamination of two or more polymer sheets. A squeegee may be attached to the edge of the sheet by trapping parts of the squeegee body between the two sheets.

The squeegee may be attached to the body of the card with various adhesive or bonding materials (e.g., acrylic, cyanoacrylate/methacrylate, epoxy, heat activated adhesives, hot melt adhesives, hydrocolloid/hydrogel, moisture-cure adhesives, polyester, silicone, urethane, UV or light-cure adhesives, etc.) that are well known to one skilled in the art. Alternatively, a groove or duct or slot may be provided for securing the squeegee. The squeegee may have corresponding features that fit into the groove or duct to enhance locking between the two parts. For example, at one edge of the card there may be a circular duct 20, as show in FIG. 4A. A squeegee 4 with a matching rod-like surface may be slid through the duct and thus attached to the body of the card. Adhesive or other bonding materials may also be used with the duct or groove to enhance the strength of the attachment. Although it is preferable that the squeegee be attached to a longitudinal edge of the card body, the squeegee may also be attached to the upper and/or lower edges of the card body.

In another variation, the device is formed of a single piece of a polymeric material. The device may be molded into the desirable shape through plastic injection molding or formed into a multi-polymer sheet by extrusion and later cut into appropriate length sections. Variations in temperature treatment, chemical treatment, doping or other methods well known to one skilled the art may be implemented to change the flexibility of the material at different sections of the device. The squeegee edge of the device is preferably softer and more flexible than the body. The flexible end may also be shaped or molded to provide good squeegee actions. Optionally, at the second edge where the material is hard, the edge may be formed or shaped to provide good scraping action. The device formed of the same piece of material as described above may have particularly low cost of production.

The surface of the squeegee may have various shapes and/or patterns to enhance its ability to remove debris from surfaces. Examples of some of the possible configurations of the squeegee are shown in FIG. 4A-4F. One or more squeegee blades or materials may also be attached to a signal edge.

In another variation, in addition to the squeegee edge, one or more scraping edge may be provided. The scraping edge may be molded on to the edge of the device during the manufacturing process. Alternatively, the scraping edge may be shaped or cut out of the body of the card. It may also be possible to attach a scraping edge to one of the edges on the body of the card. The scraping edge may comprise of metal, metal alloys, polystyrene, Acrylic, PVC, ABS, polycarbonate or other hard polymeric materials that are well known to one skilled in the art.

The scraping edge may have various shapes or features to enhance the scraping action. For examples, the scraping edge 24 may have indentations 26 or teeth 28 as shown in FIGS. 5A and 5B. In another variation, the scarping edge is serrated. Alternatively, the scraping edge 24 may comprise of a slanted surface without any special features or patterns, as shown in FIG. 6. For example, the scrapping edge 24 may be beveled or double beveled. In another design variation, as showing FIG. 7, the device comprises a card body 30 with a squeegee 4 attach along one of the edges. The squeegee is comprised of polyurethane. The card body is molded with polyvinyl chloride. A tooth shaped scraping edge 32 and a separate smooth and inclined scraping edge 34 are molded on to the card body 30. The complete device, including the card body 30 and the squeegee edge 4, has a dimension of 3.5 inch×2 inch×0.125 inch, with rounded corners.

An example of a square shaped card is shown in FIG. 8. In this example, the body 30 of the card comprises a continuous piece of polymeric material. At one edge 38, the materials have been softened and the edge is shaped to provide good squeegee action. At the opposite edge 40, the material maintains its original rigid characteristic and it is shaped to provide good scrapping action. A logo is molded onto both the front and backside of the card. In this particular example, the card has a dimension of 2.5 inch×2.5 inch.

In another aspect of the invention, a brush is provided at one or more edges of the card. The brush may comprise of natural or synthetic materials that are well known to one skilled in the art to provide sweeping action. Alternatively, the brush is comprised of synthetic polymeric fibers. The brushing edge may be implemented on the card by itself or in combination with scraping edge or brushing edge or both. FIG. 9 illustrates one variation of the device having a brushing edge 44. A brush is attached along the top edge of the card body, and a squeegee 4 is attached to the bottom edge of the card body 30. In this variation, the card body 30 may be about the size of a standard business card and the brush 46 and the squeegee 4 extend slightly beyond the boundary defined by a standard business card. In another variation, the complete device, including the brush 46 and squeegee 4 is about the size of a business card.

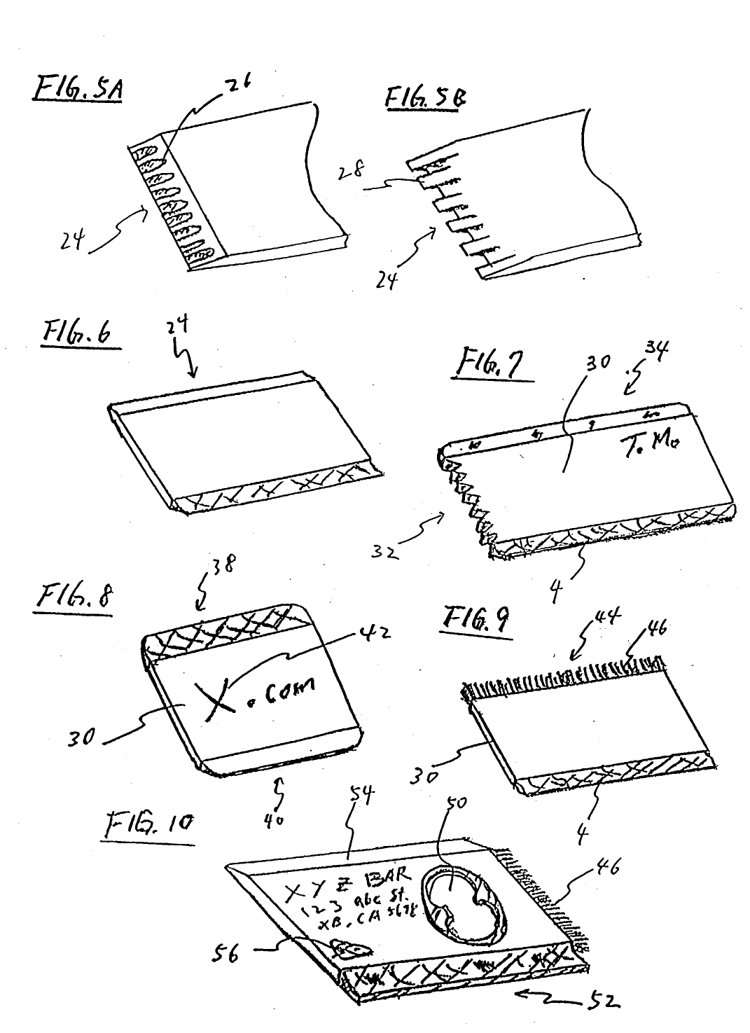

In yet another variation of the novelty business card, an opening is provided on the business card. The opening 50 may be configured such that the card may serve as a bottle opener, as seen in FIG. 10. In this variation the device has a squeegee edge 52 along one of the longer edges, which may be used to remove fluids from counter tops. The novelty card may also have a hard scraping surface 54, which may be used to remove gums or other materials that have stuck onto the counter tops. In addition, the novelty card may also have a brush 46 at another edge for sweeping dust or other particles. A key ring hole 56 may also be provided on the novelty business card if desired.

In general, metal, metal alloys or other materials with appropriate strength may be incorporated into the card device for strengthening of the device structure. In particular, strengthening materials may be incorporated during the device fabrication process to provide appropriate structure support for the bottle opener feature embedded in the card device.

In another aspect of the invention, advertising indicia such as lettering, makers, logs, boarders, advertising messages and the like may be impressed on or formed on the front and/or back surfaces of the novelty cards. Since the surface of the card may be substantially planner, an image may be imprinted conveniently thereon. In one possible approach, the image and or message may be imprinted onto the device using printing methods commonly employed in imprinting credit cards, e.g., embossing. Alternatively, dye sublimation techniques may be employed to heat transfer the desired image or messages onto the body of the card. Silk-screening techniques, offset printing, ultraviolet methods, and other methods commonly used in printing marks and letters on plastics that are well know to one skilled in the art may also be used. Alternatively, the lettering and logos may be indented or protruding form the card surface. The indented or protruding features may be formed through carving, etching, molding, or otherwise formed with manufacturing processes well known to one skilled in the art. The lettering, logos and other marks may also be molded onto the surface of the card during the manufacturing of the card body.

In one variation, a firm name, an address, a phone number, an email address and a logo are printed on the novelty business card. In another variation, a corporate logo along with an Internet address is printed on the card. One or both side of the card may have lettering or marks printed on them.

All publications and patent applications cited in this specification are herein incorporated by reference in their entirety as if each individual publication or patent application were specifically and individually put forth in the text below.

This invention has been described and specific examples of the invention have been portrayed. The use of those specifics is not intended to limit the invention in anyway. Additionally, to the extent there are variations of the invention, which are within the spirit of the disclosure or equivalent to the inventions found in the claims, it is my intent that this patent will cover those variations as well.

I claim the following:

1. A novelty business card comprising:
a rectangular plate, wherein advertising indicia is provided on a surface of said rectangular plate; and
a squeegee attached to an edge of said rectangular plate.

2. The novelty business card of claim 1 wherein a second edge of said rectangular plate is adapted for scraping.

3. The novelty business card of claim 1 wherein said plate comprises plastic.

4. The novelty business card of claim 2 wherein said second edge is beveled.

5. The novelty business card of claim 2 wherein said second edge is serrated.

6. The novelty business card of claim 5 wherein a third edge of said plate is beveled.

7. The novelty business card of claim 1 wherein said novelty business card has a length that is less than 4 inches and a width that is less than 4 inches.

8. The novelty business card of claim 7 wherein said plate has a second edge configured for scraping.

9. The novelty business card of claim 8 wherein said novelty business card is configured to be about the size of a business card.

10. The novelty business card of claim 8 wherein said novelty business card is configured with a width of about 3.5 inches and a length of about 2 inches.

11. The novelty business card of claim 8 wherein said novelty business card is configured with a width of about 9 centimeters and a length of about 5.4 centimeters.

12. The novelty business card of claim 1 wherein said novelty business card is configured to be about the size of a credit card.

13. The novelty business card of claim 1 wherein said novelty business card is configured to be about the size of a business card.

14. The novelty business card of claim 13 wherein a second edge of said plate is configured for scraping.

15. The novelty business card of claim 1 further comprising:
a brush attached to a second edge on said plate.

16. The novelty business card of claim 15 wherein a third edge of said plate is configured for scraping.

17. The novelty business card of claim 15 wherein a third edge of said plate is beveled.

18. The novelty business card of claim 16 wherein said novlety business card is configured to be about the size of a standard business card.

19. A compact device for clearing fluids or debris comprising:
a rectangular plastic plate, wherein said plastic plate is less than 1 centimeter thick, less than 3.5 inches wide and less than 3.5 inches in length, said plastic plate further comprises a first edge adapted for scraping, a second edge adapted to provide squeegee action, and a surface having a lettering, a logo, or a mark for communicating an advertising message.

20. The compact device of claim 19 wherein said plastic plate is configured to be about the size of a standard business card.

21. A novelty business card comprising:
a business card shaped body wherein a surface on said body is printed with an advertising message; and
a squeegee attached to said body.

22. The novelty business card of claim 21 further comprising:
a scraping surface attached to said business card shaped body.

23. The novelty business card of claim 21 wherein said business card shaped body further comprises an edge configured for scraping.

24. The novelty business card of claim 23 further comprising:
a brush attached said business card shaped body.

25. Method of fabricating a novelty business card comprising the steps of:
molding plastic into a rectangular shaped plate, wherein said rectangular shaped plate comprises a first edge for receiving a squeegee, and a surface for receiving an advertising indicia;
attaching a squeegee onto said first edge; and
printing an advertising indicia on said surface for receiving an advertising indicia.

26. The method of claim 25 wherein the molding step further comprises molding a second edge into a scarping surface.

27. The method of claim 25 further comprising the step of:
connecting a brush to said rectangular shaped plate, wherein said connecting step may take place before or after the attaching step.

28. The method of claim 25 wherein said rectangular plate is about the size of a business card.
